(19) United States
(12) Patent Application Publication
(10) Pub. No.: US 2014/0129788 A1
(43) Pub. Date: May 8, 2014

(54) HIGH-PERFORMANCE LARGE SCALE SEMICONDUCTOR STORAGE MODULE WITH HYBRID TECHNOLOGY

(71) Applicant: TAEJIN INFO TECH CO., LTD., Seoul (KR)

(72) Inventor: Byungcheol CHO, Seoul (KR)

(73) Assignee: TAEJIN INFO TECH CO., LTD., Seoul (KR)

(21) Appl. No.: 13/671,142

(22) Filed: Nov. 7, 2012

(51) Int. Cl. G06F 12/16; G06F 12/00

(52) U.S. Cl. 711/162; 711/154; 711/E12.103

(57) ABSTRACT

An open architecture is provided for enabling at least two memory types for a single memory disk unit. The memory disk unit includes an interface and a DMA controller. The DMA controller controls the transfer of data to/from memory of at least two memory types of the memory disk unit through a hybrid memory control module. A corresponding memory controller (and in some cases, an ECC controller) is provided for each memory of the at least two memory types. The hybrid memory control architecture can control existing memory controllers by matching protocols for the particular memory controller. Address/memory commands and signal timing can be matched up to the appropriate controller by the hybrid memory control architecture.

### BACKGROUND

A solid state disk (SSD) is a storage medium that does not have moving or rotating parts. Instead, an SSD generally uses flash memory or a volatile memory to store data. The particular memory type used in a SSD affects the characteristics of the SSD including performance, scalability and durability. For example, DRAM SSDs are faster than current flash-based SSDs and hard disk drives (HDDs). In addition, the low latency for reading and writing (the time it takes for an input or output request to complete, i.e., response time) also makes DRAM SSDs attractive for many high IOPS (the number of input or output (IO) requests per second) applications. DRAM SSDs are also useful for applications that are write intensive or have random write behavior because of DRAM SSDs' high endurance (as compared to flash).

### BRIEF SUMMARY

In accordance with various embodiments of the invention, a hybrid storage module is provided for high-performance large-scale semiconductor storage. The hybrid storage module includes at least two different types of memories that are written and read from under control of a hybrid memory control architecture. The hybrid memory control architecture can be an open architecture, facilitating the incorporation and/or substitution of current and future high performance memory storage including, but not limited to DRAM, SRAM, PRAM, and flash.

A storage system utilizing a hybrid storage module of an embodiment of the invention can take advantage of the merits of each memory type in the hybrid storage module while avoiding or minimizing disadvantages of that memory type.

According to various embodiments of the invention, a hybrid memory control architecture is provided that can be used without regard to any one particular memory type. The hybrid memory control architecture can control existing memory controllers by matching protocols for the particular memory controller. Address/memory commands and signal timing can be matched up to the appropriate controller by the hybrid memory control architecture.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a block diagram of a storage device in which a storage module of an embodiment of the invention can be incorporated.

FIG. 2 shows a block diagram of a controller of a storage device in which a storage module of an embodiment of the invention can be incorporated in accordance with an embodiment of the invention.

FIG. 3 shows a hybrid semiconductor storage module in accordance with an embodiment of the invention.

### DETAILED DISCLOSURE

Hybrid storage modules for storage systems and methods are disclosed herein. In accordance with various embodiments of the invention, a hybrid storage module is provided for high-performance large-scale semiconductor storage. The hybrid storage module includes at least two different types of memories that are written and read from under control of a hybrid memory control architecture.

A storage system utilizing a hybrid storage module of an embodiment of the invention can take advantage of the merits of each memory type in the hybrid storage module while avoiding or minimizing disadvantages of that memory type.

Embodiments of the invention are applicable to the data storage device industry of mechanical-based (e.g. HDD) and semiconductor-based (e.g. Flash or DRAM etc) data storage. Various embodiments are applicable to storage systems using data storage devices, storage networks using the storage systems, and any industry using storage networks.

According to various embodiments of the invention, a hybrid memory control architecture is provided that can be used without regard to any one particular memory type. The hybrid memory control architecture can control existing memory controllers by matching protocols for the particular memory controller. Address/memory commands and signal timing can be matched up to the appropriate controller by the hybrid memory control architecture.

In one embodiment, the hybrid memory control architecture matches protocols for the different memory types in a form of an open architecture based on a redundant array of independent disks (RAID) approach where memory allocation is controlled according to a predetermined data distribution method. By communicating with a device driver of a system, a hybrid memory control module can determine the size of data, frequency of data read/write, and importance of data from the device driver of the system, and then determine a memory in which the data is stored based on the information determined from the device driver of the system.

In a further embodiment, a separate Backup Architecture (e.g., a backup controller, backup storage, and backup power) can be coupled to the hybrid storage module to secure data safety when using volatile memories.

Conventional storage devices utilize a single type of memory for each memory disk unit that is coupled to the storage device. Even when a hybrid system is utilized in which different storage devices of different memory types are available, each memory disk unit is configured with a particular memory type. For example, one memory disk unit may be in the form of a flash or HDD type and another memory disk unit may be in the form of a DRAM SSD memory disk unit.

Because only one type of memory is used in a conventional storage device, performance of a particular module is limited according to the nature of the particular memory type forming the storage device module. For example, DRAM is known for having fast read and write cycle times. In addition, DRAM cell size is small, enabling high storage density and a very low cost per bit. However, DRAM needs to be periodically refreshed. SRAM is known for having the fastest read and write cycle times. In addition, because SRAM is a static RAM, SRAM SSDs do not need a periodic refresh cycle to preserve the stored contents. However both DRAM and SRAM based SSDs are volatile memory-based SSDs and require power to be supplied at all times to retain the data. In addition, SRAM has a large size (compared to DRAM) due to the number of transistors used for each cell, leading to lower storage density and higher cost per stored bit. Flash memory is a non-volatile memory and does not require backup power. In addition, flash memory has a fast read time. However, Flash has a longer write cycle time and performs an erase for each write.

In storage modules, when DRAM type volatile memories are used, high performance is expected but scale can be limited due to cost and size thereof. When flash memories are used, large scale is expected but performance thereof can be far lower than DRAM type.

Accordingly, in certain embodiments of the invention, high performance and large scale storage can be provided via a hybrid storage module.

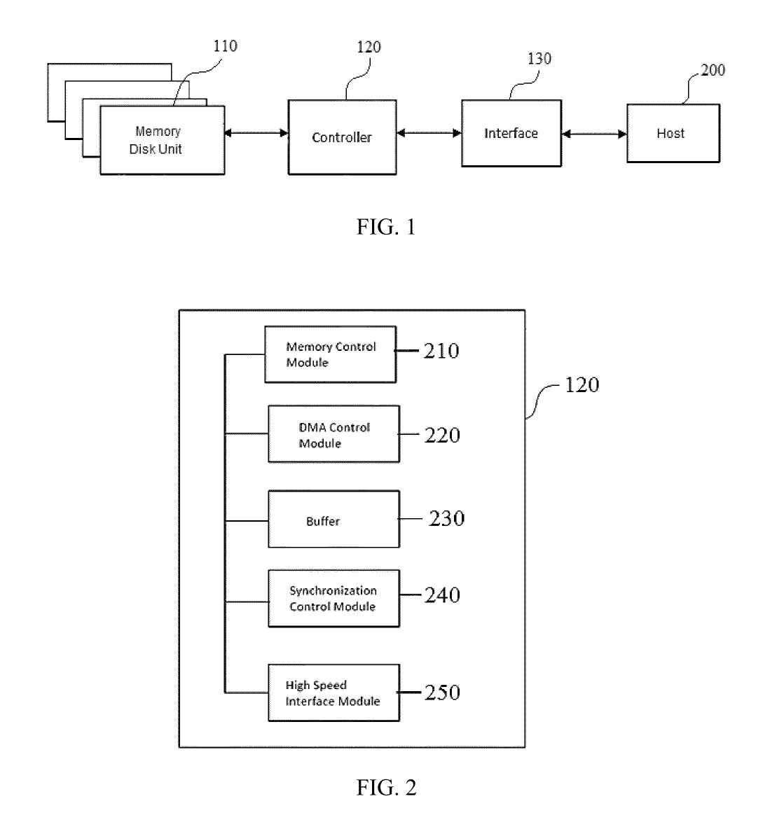

FIG. 1 shows a block diagram of a storage device of an embodiment of the invention. The storage device can include one or more memory disk units 110, a controller 120, and an interface 130 that interfaces between the memory disk unit(s) 110 and a host 200. The interface 130 to the host 200 can be any suitable interface including, but not limited to a PCI interface such as PCI-Express, Serial Attached Small Computer System Interface (SAS), or a Serial Advanced Technology Advancement (SATA). The host 200 may be a computer system or the like, which is provided with a PCI-Express interface (or SAS or SATA interface) and a power source supply device.

In one embodiment, the controller 120 can be used to adjust synchronization of data signals transmitted/received between the host interface 130 and the one or more memory disk units 110. As shown in FIG. 2, the controller 120 can include a memory control module 210 controlling data input/output of the memory disk unit 110; a direct memory access (DMA) control module 220 for directing the memory control module 210 to control the transfer of data between the memory disk unit 110 and the host 200 via the interface 130 according to an instruction from the host; a buffer 230 that buffers data for the DMA control module 220; and a synchronization control module 240 for adjusting synchronization of a data signal to provide the appropriate communication speed according to the protocol used by the host and the memory disk unit 110, which can be beneficial for systems in which the protocols result in different communication speeds. A high speed interface module 250 can also be included to facilitate the processing of data transmitted/received between the synchronization control module 240 and the DMA control module 220. The DMA control module 220 is used to transfer blocks of data including memory to memory and memory to I/O device or host processor.

Although not shown in FIG. 1, a RAID controller and backup controller can be included as part of a storage device in which a storage module of an embodiment of the invention can be used. The RAID controller and/or the backup storage controller may be part of or separate from the controller 120. A RAID controller controls the operation of the memory units, including detection of the memory units connected to the RAID controller and the storage and retrieval of data from the memory units connected to the RAID controller. A RAID controller in accordance with one embodiment of the invention can include a host interface, a disk controller, a memory module interface, a disk monitoring unit, a disk mount, and a disk plug and play (pnp) controller. Memory disk units (e.g., memory disk units 110) can be mounted onto the disk mount. The disk monitoring unit can detect whether a memory unit is mounted onto the disk mount and communicate to the disk controller whether a memory unit is mounted onto the disk mount. The pnp controller can control functions related to the disk mount when the disk monitoring unit indicates that a new memory unit is mounted. The memory module interface can facilitate communication between memory modules mounted onto the disk mount and the disk controller. The disk controller of the RAID controller is also coupled to the host interface (for example, a PCI-e interface) for communicating with the host.

The backup controller can be used with an auxiliary power source (and power source controller) to enable supply of power to the components of the storage device when primary power fails or otherwise is not supplied.

The one or more memory disk units 110 can each be in the form of a hybrid storage module of an embodiment of the invention or at least one memory disk unit 110 of the one or more memory disk units 110 is in the form of the hybrid storage module of an embodiment of the invention. Where multiple memory disk units 110 are used, the memory disk units can be arrayed in parallel.

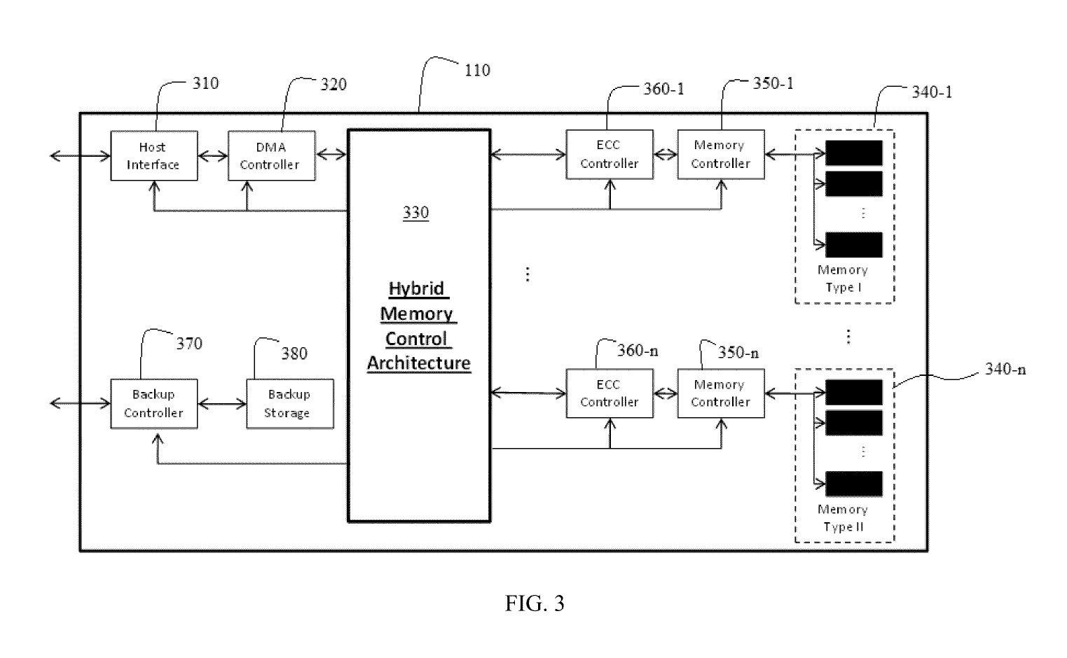

Referring now to FIG. 3, a diagram schematically illustrating a configuration of the hybrid storage module is shown. As depicted, memory disk unit 110 includes an interface 310 and a DMA controller 320. In accordance with embodiments of the invention, the DMA controller 320 controls the transfer of data to/from memory of at least two memory types of the memory disk unit through a hybrid memory control module 330. A DMA controller is used to transfer blocks of data including memory to memory and memory to I/O device or host processor.

Each memory 340-1, 340-n of the at least two memory types is controlled via a corresponding memory controller 350-1, 350-n and ECC controller 360-1, 360-n. The ECC (error correction code) controller exploits redundant memory bits (e.g., extra memory bits) of its corresponding memory to reconstruct bit errors via error-correcting code. The ECC controller can be used to detect and correct errors in the stored bits and, in some cases, indicate whether a memory has a failing sector.

In accordance with certain embodiments, the at least two memory types used for the hybrid semiconductor storage module can include, but are not limited to, volatile and non-volatile random access memories (RAM; DRAM; SDRAM—including but not limited to SDR, DDR, DDR2, DDR3 and the like; SRAM; NVRAM; NVSRAM), magnetic and ferromagnetic/ferroelectric memories (MRAM, FeRAM), phase-change random access memory (PRAM), flash memory and other volatile and non-volatile media now know or later developed that is capable of storing computer-readable information/data. Computer-readable media should not be construed or interpreted to include any propagating signals.

The hybrid memory control module 330 matches protocols needed for each particular memory of the at least two memory types. The hybrid memory control module 330 communicates with a device driver of a system via the host interface 310 to determine information on a size of data, frequency of data read/write, and importance of the data. Based on the determined information, the hybrid memory control module 330 can select the memory to which the data is stored (for writing and/or reading the data). For example, when the frequency of data writes is high, the hybrid memory control module 330 can select a DRAM memory type. Where synchronization to a particular timing protocol is needed, the hybrid memory control module 330 can facilitate the synchronization.

In one embodiment, the hybrid memory control module 330 is in a form of an open architecture based on a RAID approach where memory allocation is controlled according to a predetermined data distribution method.

A backup controller 370 and backup storage unit 380 can be further provided when volatile memory is included as one of the memory types in the storage module. In one such embodiment, the backup controller 370 can be coupled to the DMA controller 320 of the storage module via the hybrid memory control module 330 to facilitate the transfer of data from the volatile memory component of the storage module to the backup storage 380 when power failure occurs from the primary power source. An auxiliary power source can be provided on the memory disk module 110 (in the form of a battery or capacitor) or external to the memory disk module 110. The backup controller 370 can also be coupled to and communicate with the controller 120 of the storage system.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A storage device comprising:
a storage module, the storage module comprising:
a hybrid memory control module controlling a first memory controller and a second memory controller by matching protocols, the hybrid memory control module communicating with a device driver of a system to determine information on a size of data, frequency of data read/write, and importance of the data; and selecting a memory in which the data is stored according to the information received from the device driver;
a host interface; and
a controller coupled to the storage module and the host interface for controlling a data signal between the storage module and the host interface.

2. The storage device according to claim 1, further comprising a backup controller, auxiliary power, and backup storage.

3. The storage device according to claim 1, wherein at least one of the first memory controller and the second memory controller is coupled to a volatile memory type memory.

4. The storage device according to claim 3, the storage module further comprises a backup controller coupled to the hybrid memory control module to backup data from the volatile memory type to a backup storage.

5. The storage device according to claim 1, wherein the first memory controller is coupled to a memory of a first volatile memory type and the second memory controller is coupled to a memory of a second volatile memory type different than the first memory type.

6. The storage device according to claim 1, wherein the first memory controller is coupled to memory of a volatile memory type and the second memory controller is coupled to memory of a non-volatile memory type.

7. The storage device according to claim 1, wherein the storage module further comprises a DMA controller coupled to the host interface and the hybrid memory control module, the DMA controller controlling the transfer of data to/from memory coupled to the first memory controller and the second memory controller through the hybrid memory control module.

8. The storage device according to claim 1, wherein the storage module further comprises a first ECC controller coupled to the first memory controller and a second ECC controller coupled to the second memory controller.

9. A storage module comprising:
a plurality of memory controllers correspondingly coupled to memory of a plurality of memory types, the plurality of memory controllers comprising a first memory controller coupled to a first memory type memory and a second memory controller coupled to a second memory type memory, the second memory type being different than the first memory type; and
a hybrid memory control module controlling each of the plurality of memory controllers by matching protocols, the hybrid memory control module communicating with a device driver of a system to determine information on a size of data, frequency of data read/write, and importance of the data; and selecting a memory from a memory type of the plurality of memory types correspondingly coupled to the plurality of memory controllers in which the data is stored according to the information received from the device driver.

10. The storage module according to claim 9, further comprising:
a host interface; and
a DMA controller coupled to the host interface and the hybrid memory control module, the DMA controller controlling the transfer of data to/from memory coupled to the plurality of memory controllers through the hybrid memory control module.

11. The storage module according to claim 9, further comprising:
a first ECC controller coupled to the first memory controller and a second ECC controller coupled to the second memory controller.

12. The storage module according to claim 9, wherein at least one of the first memory type and the second memory type is a volatile memory type.

13. The storage module according to claim 12, the storage module further comprises a backup controller coupled to the hybrid memory control module to backup data from the volatile memory type to a backup storage.
